(19) United States
(12) Patent Application Publication
(10) Pub. No.: US 2004/0103726 A1
(43) Pub. Date: Jun. 3, 2004

(54) Bond test systems with offset shear tool

(76) Inventor: Malcolm Cox, Napa, CA (US)

Correspondence Address: Malcolm Cox, 500 Gateway Drive, Napa, CA, 94558, US

(21) Appl. No.: 10/719,947

(22) Filed: Nov. 20, 2003

Related U.S. Application Data
(60) Provisional application No. 60/430,111, filed on Dec. 2, 2002.

(51) Int. Cl. G01N 3/24

(52) U.S. Cl. 73/842

(57) ABSTRACT

A tool 1 to be installed into a test module 6 of a Bond Test System 5 to provide the capability to directly view a bond shear test. This capability enables a vision system camera 9 coupled to magnifying optics 8 to provide real time viewing, image capture, and vision guided automation for more effective analysis, additional analytic capability and improved ergonomics. This greatly enhances the utility of the shear test function of the Bond Test System 5.

### CROSS-REFEENCE TO RELATED APPLICATIONS

Not applicable

### BACKGROUND

1. Field of Invention

This invention relates to a novel and unique shear tool utilized in conjunction with a Bond Test System employed in the manufacture of microelectronics devices, for the expressed purpose of allowing a CCD camera based electronic vision system to have an unobstructed normal view of the shear test, thus enabling real time targeting, image capturing and remote viewing of bond tests and automated testing.

2. Description of Prior Art

Various structures of microelectronic devices employ bonding techniques as part of the assembly of the devices, most notably, but not limited to, wire lead connections that interconnect integrated circuit chips to external lead frames, ball or bump bonds, or die bonds. Highly accurate test systems exemplified by Royce Instruments Inc model 552 and 580 Bond Testers have been developed to measure the strength of these bonds as a means of process control, development, failure analysis or quality assurance. Bonds to be tested are of such small size that practical viewing requires magnification.

The test systems with currently available features require manual alignment via an operator looking through a microscope at a partially obstructed view of the shear tool position relative to the ball to be tested, then moving the test site to be positioned directly under a video system for capturing the image This is currently undesirable for the following reasons:

a) Current shear tool, test transducer and microscope arrangements do not allow direct viewing of the shear test and forces the microscopes required to set-up tests to be placed in an ergonomically compromised position.

b) The targeting of the ball to be tested is not in real time, the operator does not have a normal view of the shear tool relative to the bond to be tested and must therefore infer its position from a partial front angle view.

c) The requirement to view the test set-up for alignment through microscope eyepieces is tedious to operators.

d) Current shear tool designs must be mounted in force sensing test transducers such that the microscope is prevented from being positioned to look straight down on the test.

e) The shear test cannot be viewed dynamically.

f) Only one person, the operator, may view the test.

g) The bond test site must be moved from the test position to another position where a video system may have a normal viewing angle (90° to the shear plane). It must then be moved back to return to the test position to be ready for the next test.

h) A vision system cannot be employed to automatically index and accurately align the test tool with real time feedback.

### SUMMARY

The invention described herein embodies a special tool used in a Bond Test System that contacts the ball bond to be tested. Said tool engages the ball to be tested at a preset height above the substrate plane as it is driven into it to shear its bond to the substrate. The shear force is sensed and measured, typically by parallel beam mounted strain gauges. The tool features a novel design that extends its active tip out past the vertical plane of the transducer and its test module enclosure. The extension allows the alignment and test to be viewed with a look down video system. The ability to employ a look down video system offers numerous advantages.

### OBJECTS AND ADVANTAGES

Objects and advantages of the invention are:

a) To provide a means to view the test at a normal angle.

b) Allows use of closed circuit television (CCTV) system instead of microscope.

c) To reduce or eliminate operator induced errors. Accurate tool positioning.

d) Allows auto positioning w/computer controlled electronic vision system and full automatic testing.

e) Enables ergonomically comfortable viewing, reduces operator fatigue.

f) No extra and time consuming X-Y table moves are required to bring test site into position for an image capture camera and back for next test.

g) Allows multiple viewers to simultaneously observe tests, either directly or remotely.

h) Allows real time and dynamic viewing of a shear test.

### DRAWING FIGURES

FIG. 1 shows an overview of a Bond Test System with Image Capture optics and incorporation of an offset shear tool

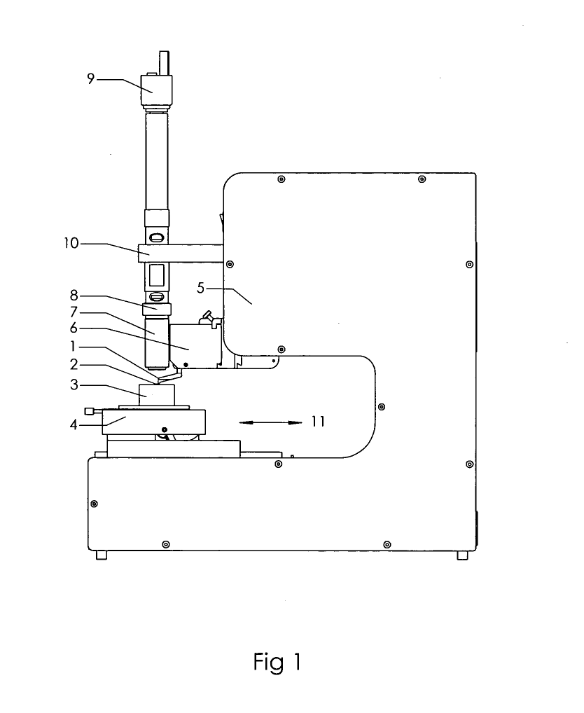

FIGS. 2A and 2B show detail of the offset shear tool

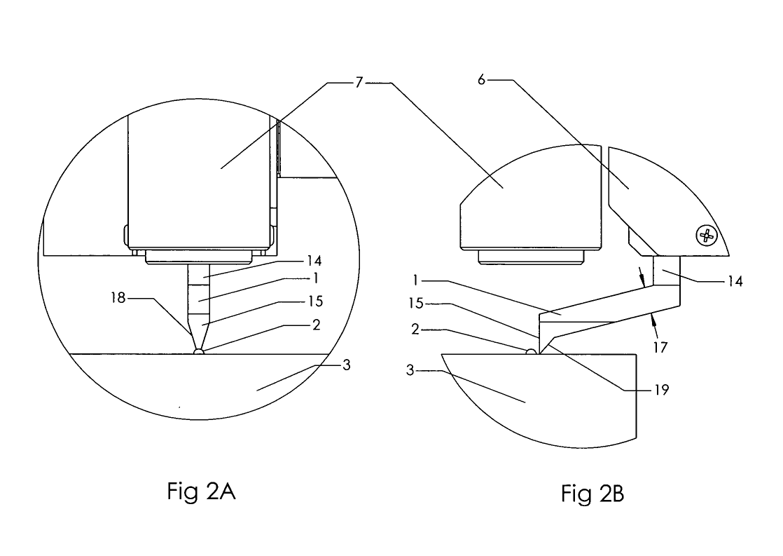

FIG. 3 shows the required position of the bond to be tested to the centerline of the image capture optics and how the offset shear tool facilitates shear testing of the bond directly under the optics

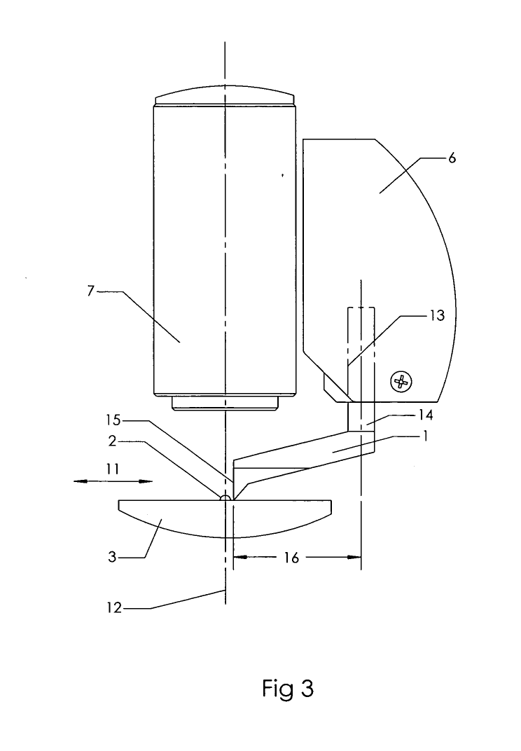

### REFERENCE NUMERALS IN DRAWINGS

1 Offset shear tool

2 Ball Bond or Bump to be shear tested

3 Test piece in holder

4 Movable X-Y stage of tester

5 Bond Tester

6 Test module incorporating a force measurement transducer

7 Objective lens

8 Optics for Image Capture feature of Bond Tester

9 CCD Video camera

10 Optics mount

11 Stage movement to shear bond and return

12 Centerline of optics and bond test site

13 Flat for alignment

14 Shank to fit into test module

15 Shear face of tool

16 Offset of shear tool

17 Section size suitable to transfer forces

18 Clearance angles

19 Bottom rake

### DESCRIPTION—PREFERRED EMBODIMENT

The preferred embodiment of the invention follows.

a) The special shear tool 1 features an offset 16 design that transfers the shear test force from a test area that can be viewed from a normal direction to the load axis of the force measurement transducer of the test module 6.

b) The tool features a blade edge on the shear face of the tool 15 that contacts the ball or bump to be tested, to contact only one ball or bump 2 per test, sized to be least as wide as the ball diameter with additional width for alignment tolerance, but no wider than the pitch distance between balls. Typical width is 1.5×ball diameter.

c) A keyed shank 14 with a flat 13 that allows fitment into the receiver socket of the force measurement transducer of the test module 6 in the correct position and orientation.

d) A section size 17 suitable to transfer the forces of the shear test from the shear face 15 to the shank 14.

e) Clearance angles from shear face 15 to shank 18 to prevent interferences to other areas of the test piece.

f) Bottom rake angle 19 to limit contact of ball or bump 2 to the bottom of the offset shear tool 1 during test

g) The special offset shear tool 1 is incorporated and works in concert with a Bond Test System 5 that features:

a. A force measurement transducer housed in a shear test module 6 attached to a Z axis (vertical) drive to move the offset shear tool 1 up and down.

b. An X-Y stage 4 to align the test piece 3 to the offset shear tool 1 and move the test piece 3 into the offset shear tool 1 to perform the shear test. A CCD video camera 9 based electronic vision system to magnify, display and capture an electronic image of the bond 2 site after the shear test is complete. The vision system is capable of automatically targeting the bond 2 to be tested and aligning it to the offset shear test tool 1.

c. Controls and software for operation and data collection.

Advantages:

a) The special offset shear tool enables the shear test to be accomplished such that the test may be viewed without obstruction in a normal view.

b) The ability to observe the test in a normal view allows the direct use of look down optics and CCD based electronic vision systems.

c) The electronic vision systems allow:

a. Automated targeting and alignment.

i. Enables fully automatic testing.

b. Real time viewing of the test.

i. Enables observation and analysis of test dynamics.

c. Efficient capture of the image.

i. Allows image storage.

ii. Allows comparative analysis.

iii. Allows image sharing between remote sites.

d. Qualitative analysis of defects or desirable features.

d) Observation of the test and its set-up via a monitor:

a. Eliminates the need for a microscope.

b. Provides comfortable ergonomics.

i. Reduces operator fatigue.

ii. Reduces operator-induced errors.

iii. Allows simultaneous viewing by multiple observers.

Operation:

The offset shear test tool 1 is used in the shear test operation as follows:

a) The shank 14 of the offset shear test tool 1 is installed into the socket of the force measurement transducer in the test module 6. The flat 13 properly orients the tool.

b) The Bond Test System's 5 Image Capture optics 8 are aligned and focused on the blade edge of the shear face 15 of the offset shear tool 1 in position at the bond to be tested 2.

c) For set up or manual operation, the operator positions the motorized X-Y stage 4 of the Bond Test System 5 to bring the bond to be tested 2 into proper position ahead of and in proper alignment with the shear face blade edge-15 of the offset shear test tool 1. The operator views the test area on a monitor that displays a real time magnified video image and manipulates the X-Y 4 stage as required to achieve alignment.

d) The test sequence is initiated, the offset shear test tool 1 is lowered and set at a predetermined shear height and the stage 4 drive pushes the ball or bump 2 into the blade of the offset shear test tool 1 via movement 11.

e) The force required to shear though the ball or bump 2 is detected by the test module 6 and recorded by the Bond Test System 5.

f) The tool 1 is lifted and the test site is returned by movement of the stage 11 to the start position directly under the optics 8.

g) The remnants of the tested bond are now available for viewing and analysis. A permanent image of the bond test site may now be captured electronically via the camera 9.

h) The system is ready for the next test.

i) For automatic operation, the system may use the capability of the CCD video camera 9 and vision system to automatically locate and align the bond 2 and may also index to the next bond to be tested in a fully automatic sequence.

Conclusion, Ramifications and Scope:

The ability to deploy the shear tool's active surface, its blade edge, in a manner such that its geometry allows extension past the test system's other necessary components without compromise of its ability to accurately transfer the shear force imparted to the test bond to the transducer that measures that force, enables direct top down viewing of a shear test. As such, the requisite magnifying optics may be placed to access undistorted views of the bond test from the most useful position, and those views may be captured as electronic images to be stored and displayed on a monitor. This enables the shear test to be viewed on a monitor, a much more ergonomic means of observation than through a microscope thus reducing operator fatigue and error. It also allows viewing by more than just the operator, enabling better operator training, supervision and analysis of results. The dynamics of the test may be observed in real time also, consequently opening up the possibility for better understanding and refinement of the test process. The image can be stored for later retrieval and remote analysis or sharing of information with other sites. Direct image comparisons may be made to other images for comparative analysis. Vision systems may be employed to quantify defects or desirable features, and vision guidance systems may be utilized to automatically target and align the bonds to be tested. The automatic alignment and targeting capability enables full automation of tests, especially useful for testing of very small bumps on large diameter wafers where select bumps are to be tested on predetermined or programmable patterns that are very tedious and easily incorrectly accomplished manually.

I claim:

1. A bond test shear tool incorporating typical features of shear face and blade edge thereof, mounting shank with orienting provision and clearances and rakes to appropriately make contact with ball bonds or bumps for the purposes of shear testing the strength of the bonds of such balls or bumps to their underlying substrates, the improvement wherein said shear tool features an offset that places the shear face beyond interferences to view by normally mounted optics.

2. A bond test system that accepts the offset shear tool of claim 1 and provides for the positioning of the image capturing optics and the shear force test module, the improvement wherein said bond test system provides unobstructed real time views of the shear test and the subsequent sheared test site directly over and normal to the bond test location.
